(19) United States
(12) Patent Application Publication
(10) Pub. No.: US 2017/0316411 A1
(43) Pub. Date: Nov. 2, 2017

(54) TRANSACTION VERIFICATION AND AUTHORIZATION

(71) Applicant: III Holdings 1, LLC, Wilmington, DE (US)

(72) Inventors: Charlie Kimes, Scottsdale, AZ (US); Clint Lowry, Phoenix, AZ (US); Romit Misra, Phoenix, AZ (US); David Tanner, Phoenix, AZ (US)

(21) Appl. No.: 15/490,441

(22) Filed: Apr. 18, 2017

Related U.S. Application Data
(63) Continuation of application No. 12/948,629, filed on Nov. 17, 2010, now abandoned.

(51) Int. Cl. G06Q 20/40; G06Q 20/12; G06Q 30/04

(52) U.S. Cl. CPC G06Q 20/40; G06Q 30/04; G06Q 20/12; G06Q 20/4016

(57) ABSTRACT

A system and method for fraud prevention is provided. The computer based system and method comprises receiving a request for verification services by a merchant transmitted via an Internet browser based platform, performing a fraud assessment by a verification services tool resulting in a verification message, and transmitting a reply to the merchant via an Internet browser based platform including a verification message.

### FIELD OF INVENTION

The present disclosure generally relates to electronic commerce, and more particularly, to a system and method of validation, tracking and security associated with electronic commerce.

### BACKGROUND OF THE INVENTION

Credit cards, charge cards, and other transaction instruments are commonly accepted today as a form of payment under a variety of circumstances. A transaction instrument may be used to complete a purchase in-person (e.g., at a retail store, a restaurant, or a hotel) by physically presenting a merchant with the transaction instrument. A transaction instrument may also be used to complete a purchase without physically presenting the transaction instrument by relaying information associated with the transaction instrument (e.g., account number, account name, expiration date, and billing address) to a merchant. Examples of merchants that accept transaction account information as payment, without physically receiving the transaction instrument include Internet, telephone and mail order merchants.

Because many parties are often involved in facilitating payments, data associated with facilitating payments can experience fraud. A transaction instrument may be copied, or information about a transaction instrument necessary to complete purchases may be stolen. While the account holder and card issuer are unsuspecting of any fraudulent activity, numerous fraudulent purchases may be charged to the account holder's transaction instrument.

Merchants and financial institutions have been limited in the tools available for identifying, tracking and preventing fraudulent transactions. Multiple middle actors traditionally exist between a merchant and a transaction account issuer and/or financial institution. It is often difficult or impossible for the transaction account issuers to ascertain the identities of these middle actors. Moreover, the software of the merchants and the middle actors has complicated the integration and communication of new services, including fraud tools, between a merchant and a transaction account issuer.

Given the foregoing, a strong need exists for a system, method and computer readable medium that may be used to quickly validate information and assist with identifying fraudulent transactions.

### SUMMARY OF THE INVENTION

The present disclosure includes, in one embodiment, a computer based system and method for receiving a request for verification services by a merchant transmitted via an Internet browser based platform, performing a fraud assessment by a verification services tool resulting in a verification message, and transmitting a reply to the merchant via the Internet browser based platform including the verification message.

### BRIEF DESCRIPTION OF THE DRAWINGS

A more complete understanding may be derived by referring to the detailed description and claims when considered in connection with the Figures, wherein like reference numbers refer to similar elements throughout the Figures, and:

FIG. 1 is a block diagram illustrating an exemplary path to transmit and/or receive a transaction authorization request and/or transmit data associated with a fraud mitigation tool in accordance with an exemplary embodiment;

FIG. 2 is a block diagram illustrating a method for performing a fraud assessment associated with a transaction request in accordance with an exemplary embodiment; and

FIG. 3 is a block diagram of an exemplary computer based system for implementing various embodiments of the disclosure.

### DETAILED DESCRIPTION

The detailed description herein is presented for purposes of illustration only and not of limitation. For example, the steps recited in any of the method or process descriptions may be executed in any order and are not limited to the order presented. For the sake of brevity, conventional data networking, application development and other functional aspects of the systems (and components of the individual operating components of the systems) may not be described in detail herein. Any references to plural may include singular, and any references to singular may include plural.

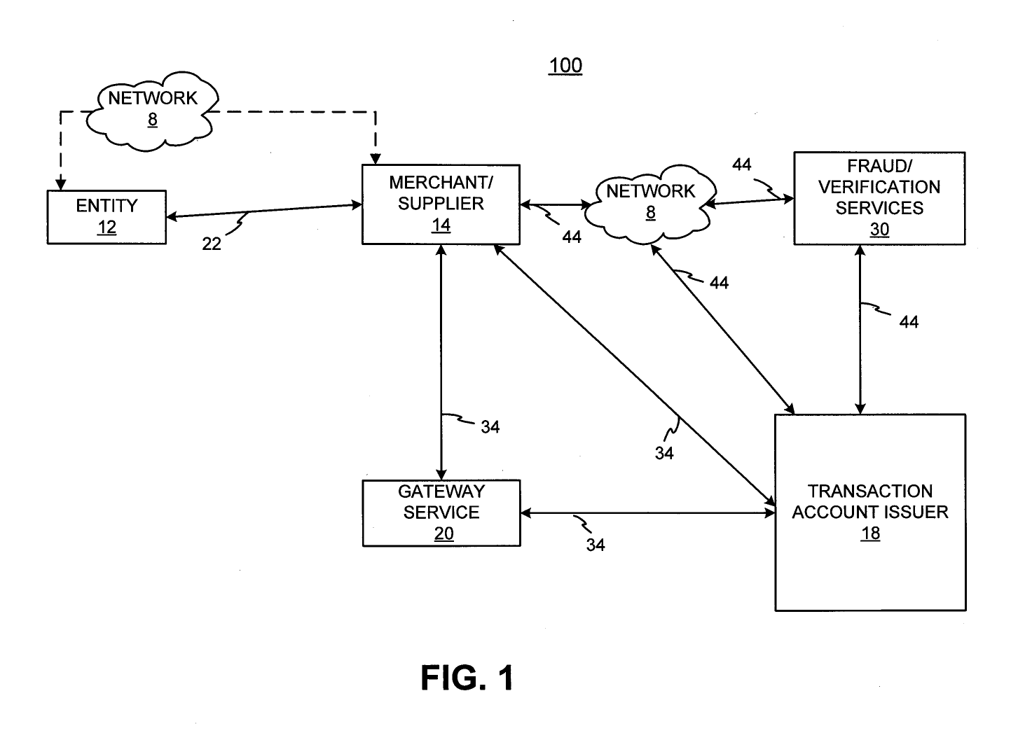

One exemplary embodiment, with reference to FIG. 1, may include a tool for preventing or minimizing fraud, wherein the tool is used by a merchant 14 and/or a provider of fraud/verification services (e.g., a financial institution and/or transaction account issuer 18). This tool for fraud prevention may be an Internet browser based tool. For instance, an entity 12 may interact with merchant 14 in person (e.g., at the box office), telephonically, or electronically (e.g., from a user computer via a network 8 such as the Internet) to initiate and complete a transaction and/or purchase (e.g. transmit a transaction request 22). When interacting in person, an entity 12 may physically present a transaction instrument to merchant 14 as a form of payment. When communicating with merchant 14 through a telephone or a computer (e.g., using a web enabled computer, point of sale device, kiosk, terminal or the like), an entity 12 may provide information associated with a transaction account (e.g., transaction account number or code, expiration date, account name, and billing address) to merchant 14 to complete a payment.

Along with providing a transaction instrument and/or transaction account information as payment, entity 12 may provide additional information to merchant 14 in response to conducting a purchase. For example, entity 12 may provide a ship-to-address or a ship-to-name that may be different than a name or billing address associated with the transaction instrument. Entity 12 may provide and/or transmit an email address or a contact telephone number to merchant 14 for a specified action, so that entity 12 may be updated with the status of a purchase.

Furthermore, merchant 14 may obtain additional information about entity 12 from other sources in response to interacting with entity 12. For example, if entity 12 is communicating with merchant 14 over a telephone, merchant 14 may receive an automatic number identification (ANI) and a corresponding information identifier (II) for entity 12 from a telephone company. ANI provides the telephone number of the telephone used by entity 12 to communicate with merchant 14. II identifies the type of telephone used by the entity such as, for example, a cellular telephone, coin-operated telephone, prison telephone, or a standard land-line telephone. In another example, if entity 12 is communicating with merchant 14 over the Internet, the Internet Protocol (IP) address of the machine that entity 12 used to initiate the purchase may be captured by whatever Internet-based commerce system that was utilized by merchant 14. Additionally, transaction level data such as information regarding the goods or services purchased may be communicated to transaction account issuer 18.

Upon receipt of a transaction request 22, merchant 14 may submit a transaction authorization request 34 to an authorization system and/or payment system to accept the transaction code. This submitted request may be via a gateway service 20. The transaction authorization request 34 is transmitted to the payment system and/or authorization system. These authorization requests may be sent to the authorization system and/or transaction account issuer 18 over, for example, any network 8, intranet, the Internet, wireless communications, application program interface (API) and/or the like.

Merchant 14 may also send a fraud assessment and/or request 44 for verification services 30 (described in further detail below) associated with captured and/or provided entity information, transaction instrument data, payment information, and enhanced authorization data. Examples of enhanced authorization data include, for example, an ANI, an II, an email address, a contact telephone number, a ship-to-name, a ship-to-address, customer hostname, HTTP browser type, ship to country, shipping method, product SKU, number of cities, an IP address, a seller identification, and/or descriptors of goods or services associated with the transaction.

The fraud assessment and/or request for verification services request 44 may be sent in association with a transaction authorization request 34 (e.g., parallel with a transaction authorization request 34, after a transaction authorization request 34, in response to sending a transaction request 34, in a batch, in response to receiving a transaction request response and/or prior to sending/receiving an authorization request 34). A fraud assessment and/or request for verification services request 44 may be sent from a merchant 14 to a transaction account issuer 18 at any time, with or without an associated transaction authorization request 34.

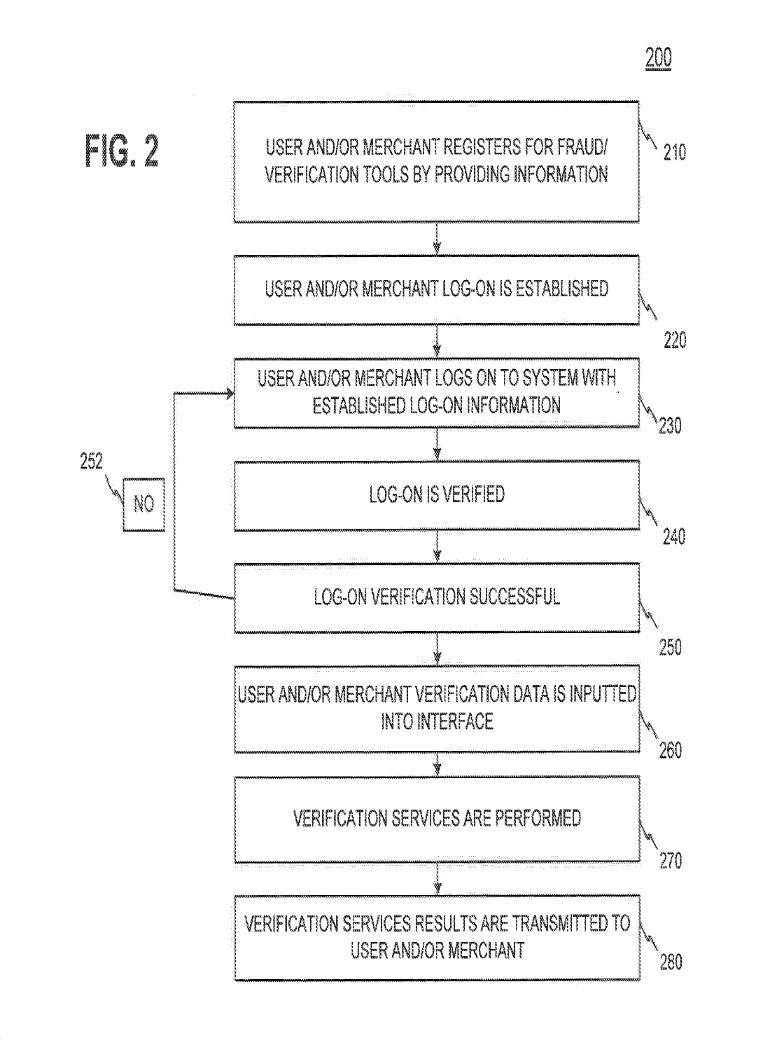

In an exemplary embodiment, and with reference to FIG. 2, merchant 14 may register to access fraud and/or verification services 30 (210). This registration may be facilitated through any suitable methods. For instance, merchant 14 may provide information to an operator of the fraud and/or verification services 30, such as transaction account issuer 18, third party and/or financial institution. The merchant may provide this registration information, by mail, over the telephone, or electronically (e.g., using a computer via a network, such as the Internet). In an embodiment, this registration communication may be made through a browser based Internet interface.

The registration request of merchant 14 to register for access to verification services 30 and/or verification service tools may include merchant data such as at least a portion of the merchant's identification code, at least a portion of merchant banking routing number, at least a portion of merchant transaction account code, and/or postal code associated with the merchant. This merchant data may be cross-referenced by transaction account issuer 18 against previously stored merchant 14 data. In response to a match of information a specific merchant log-on may be issued to the merchant (220). This merchant 14 log-on may be location specific, and/or merchant 14 account specific. Merchant 14 may be issued a vanity URL to access the log on screen and/or access the verification services. This registration may facilitate a security function as transaction account issuers 18 and financial institutions may control and track access to the fraud and/or verification services 30.

Merchant 14 may use a web browser based interface log on to utilize the verification services 30 (230). A front-end and back-end verification may be performed on the provided log-on information (240). If the provided log-on information fails either verification, merchant 14 may be directed to provide corrected information and/or contact log-on support (252).

Upon successful log-on, merchant 14 may be presented with an interface to provide fraud and verification services information (250). The log-on of a secure session may time out and log merchant 14 out and/or suspend access until merchant 14 provides renewed log-on information, after a period of non-use of the merchant's 14 system or use of the browser based tools.

The transaction account issuer may perform a fraud assessment and or verification based upon the transmitted and/or received information (260). This verification information may include the number of (simultaneous) requests merchant 14 wishes to perform. Merchant 14 may perform any desired number of requests. Verification services 30 (as further described below) may be performed by a verification services provider such as a financial institution and/or transaction account issuer 18 (270). The results of this verification may be transmitted to merchant 14 (280). A decision to process the transaction may be made at least in part based on the content of the verification result.

In one exemplary embodiment, a request for fraud services may include transmitting enhanced authorization data and/or utilizing fraud tools. Examples of services, data and tools include as disclosed in pending U.S. patent application Ser. No. 11/303,018, entitled “System, Method And Computer Program Product For Authorizing Transactions Using Enhanced Authorization Data,” filed Dec. 16, 2005; U.S. patent application Ser. No. 10/588,811, entitled “System And Method Using Enhanced Authorization Data To Reduce Travel Related Transaction Fraud,” filed Jun. 11, 2007; U.S. patent application Ser. No. 12/205,412, entitled “Method, System, And Computer Program Product For Customer-Level Data Verification,” filed Sep. 5, 2008; and U.S. patent application Ser. No. 12/874,063, entitled “Application Program Interface Based Fraud Mitigation,” filed Sep. 1, 2010; the contents of all documents are hereby incorporated by reference for any purpose in their entirety.

In one embodiment, enhanced authorization data and authorization data, such a transaction account code, transaction account holder name, addresses associated with the transaction account and postal code associate with the transaction account may be imputed by a merchant 14 via the Internet browser based web interface into a request for fraud and/or verification services 44. A fraud assessment may be performed based on a comparison of one or more elements of the received data and data internal data and third party data stored to a database. A response may be issued in response to the comparison. The decision to complete the transaction may be made in part based on the response from the verification system. For instance, a response indicating one or more of the enhanced authorization data and authorization data is correct based on the comparison and/or one or more of the enhanced authorization data and authorization data is incorrect or unavailable may be provided.

For instance, a verification services tool and/or request for fraud services may include transmitting and receiving enhanced authorization data. This enhanced authorization data may be sent in concert with an authorization request 34 in an appended authorization request 34 and/or in a separate request by through an Internet based web browser. The enhanced authorization data may include at least one of an email address; automatic number identification; a contact telephone number; a ship-to-name; entity name; passenger name; a travel date; a routing description; an electronic ticket indicator; an origin city; a destination city; a class of service; a number of passengers; a reservation code; carrier code; a ship-to-address; an Internet Protocol (IP) address; an information identifier and/or seller identification information.

In an embodiment, a fraud mitigation tool and/or request for fraud/verification services may include transmitting or receiving (from merchant 14 for use in real-time authorization) transaction variables for a transaction involving a purchase of a travel ticket using the financial account such as through an Internet based web browser. The transaction variables may include at least one of a passenger name on the travel ticket, a travel date, a routing description of the travel ticket, and/or an electronic ticket indicator; and processing the transaction variables through a fraud-risk model to determine a risk factor for the transaction. The transaction authorization request 34 may be approved based on the risk factor being within a range of acceptable values. A purchasing history of the account holder may be retrieved from a database. The transaction authorization request 34 may be approved based on the risk factor and the purchasing history. In one embodiment, a status of the transaction account may be retrieved. The transaction authorization request 34 may be approved based on the risk factor and the status. The transaction authorization request 34 may be declined in response to the risk factor being within a range of unacceptable values.

In an embodiment, the verification services tool and/or request for fraud/verification services may include receiving a first data element including first transaction account data identifying a first transaction account, and receiving a second data element. Entity 12 may be determined from the first transaction account data. A second transaction account associated with entity 12 may be identified. A determination that the second data element does not match a corresponding data element associated with the first transaction account may be made. The second data element may be compared with entity 12 record including second transaction account data identifying the second transaction account. The second transaction account data may be compared with the first transaction account data. A comparison result may be generated to verify the first data element based on the comparing. The comparison result may indicate that entity 12 is associated with an account corresponding to the first transaction account.

In another embodiment, this request for fraud/verification services may include transmitting information associated with products involved with the transaction to identify risk associated with the transaction as disclosed in pending U.S. patent application Ser. No. 12/416,675, entitled “Authorization Request For Financial Transactions,” filed Apr. 1, 2009; the contents of which are hereby incorporated by reference for any purpose in their entirety. For instance, a verification services tool and/or request for fraud services may include automatically identifying at least one product from a purchase order associated with the transaction, the identification being performed based on an electronic comparison between a predefined list of products and the purchase order. A fraud mitigation tool and/or request for fraud services may include sending product details of the product through a third party (such as with an authorization request) and/or through an Internet based web browser to the financial institution. In this embodiment a notification may be received from the financial institution through an Internet based web browser and/or through a third party, wherein the notification includes an authorization decision based on the product details. In this embodiment, the predefined list of products may be defined by the financial institution and/or transaction account issuer 18. The predefined list of products may be defined based on financial risk associated with a plurality of products. A unique code may be associated with each product in the predefined list of products. The unique code associated may be defined by the financial institution and/or transaction account issuer 18 and may be included as a field in the electronic transaction authorization request and/or sent separately through an Internet based web browser tool.

In another embodiment, a request for fraud services may include transmitting a post-authorization message for a financial transaction as disclosed in pending U.S. patent application Ser. No. 12/416,680, entitled “POST-AUTHORIZATION MESSAGE FOR A FINANCIAL TRANSACTION,” filed Apr. 1, 2009 the contents of which are hereby incorporated by reference for any purpose in their entirety. For instance, a post-authorization message may be sent from a merchant 104 to a transaction account issuer directly through an Internet based web browser. In this embodiment, an assessment of the feasibility of the financial transaction may be made by parties to the transaction, such as by the merchant. The financial transaction is processed based at least in part on the feasibility assessment. The financial institution and/or transaction account issuer may be provided with an electronic post-authorization message through a third party and/or through an Internet based web browser. The electronic post-authorization message may comprise details related to the processing of the financial transaction including information related to the feasibility assessment.

In one embodiment, enhanced authorization data and authorization data, such a transaction account code, transaction account holder name, email address associated with the transaction account, date of last address change, country of transaction account issuance, addresses associated with the transaction account and postal code associated with the transaction account may be captured automatically during a transaction request 22. At least part of this captured data may be automatically populated into the web based interface to perform an automatic request for fraud services 44. The decision to complete the transaction may be made in part based on the response from the verification system.

In one embodiment, the system may return a response to each request for fraud and/or verification services 30. These responses may include content such as the identifiers: Correct, Incorrect, Retry, and Unchecked. A response of Correct indicates that the information in the field is valid and/or aligns with the details saved in a database. A response of Incorrect indicates that the data entry is invalid and does not align with the details saved to a database. Optionally, data may be inputted incorrectly and a correction may be made to this inputted data without the need to create a new inquiry in the system. A response of Retry indicates the system is temporarily unable to verify the data associated with the fraud check. A second verification can be processed immediately (without the need to re-enter information). A response of Unchecked indicates that the information cannot be verified due to a substantially permanent data limitation (such as missing verification information saved to a database). A holder of a transaction account, such as entity 12, may be contacted to provide additional information in associated with a response of Unchecked.

In one embodiment, the system may be used by merchants to alleviate hearing or speech communication constraints. Merchants experiencing difficulty using the system may contact live support. This contact may be through a pop-up text window, telephonically, or through any other suitable means. The operator of the fraud and/or verification services tool may perform updates to its fraud prevention tools and systems without software and/or hardware updates required by the merchant. The request to register a merchant may be made by a third party, such as a representative of the transaction account issuer and/or third party merchant. Upon granting access to the system, log-on information and/or user guide materials may be transmitted via a link to the requestor and/or registered merchant. In one embodiment, the merchant does not utilize middle actors, such as vendors, processors, gateways and/or middleware associated with vendors, processors, gateways to transmit a request to access verification services to a financial institution and/or transaction account issuer.

Additionally, with renewed reference to FIG. 1, transaction account issuer 18 may also utilize the tool internally. This internal use, reduces duplication of systems and may add consistency to responses. For instance, an internal transaction account issuer representative assisting merchant 14 with a fraud check telephonically may enter data provided by the merchant 14 into the web browser based interface to perform a fraud check. The internal transaction account issuer representative may reply the findings as processed by the system to merchant 14 over the telephone or any other suitable communication means. The internal transaction account issuer representative may append fraud services request with specific merchant 14 requestor information for use tracking purposes. In another embodiment, the transaction account issuer 18 may also utilize the tool internally without an associated merchant request for assistance.

The financial institution and transaction account issuer 18 may store user data associated with requests for fraud and/or verification services. The operator of the fraud and/or verification services may use the data to enhance its fraud and verification assessments and/or risk profiles. For instance, the transaction of a merchant associated with processing with a high amount of fraudulent transactions may be given higher scrutiny to, for instance, to protect both a financial institution and the merchant. A discount for services may be offered to the merchant based upon use of the system. A discount may be offered to the merchant based on the reduction of use of other fraud verification tools, such as reductions in contacting live support personnel of the transaction account issuer.

Reports may be generated detailing a merchant's use of the system. These reports may represent a specific merchant's use of the system and results compared against the specific merchant's industry, similar sized merchants, similar geographic merchants, and merchants dealing in similar good and services. These reports may detail aggregate identified fraud to the transaction account issuer. These reports may be provided to the merchant.

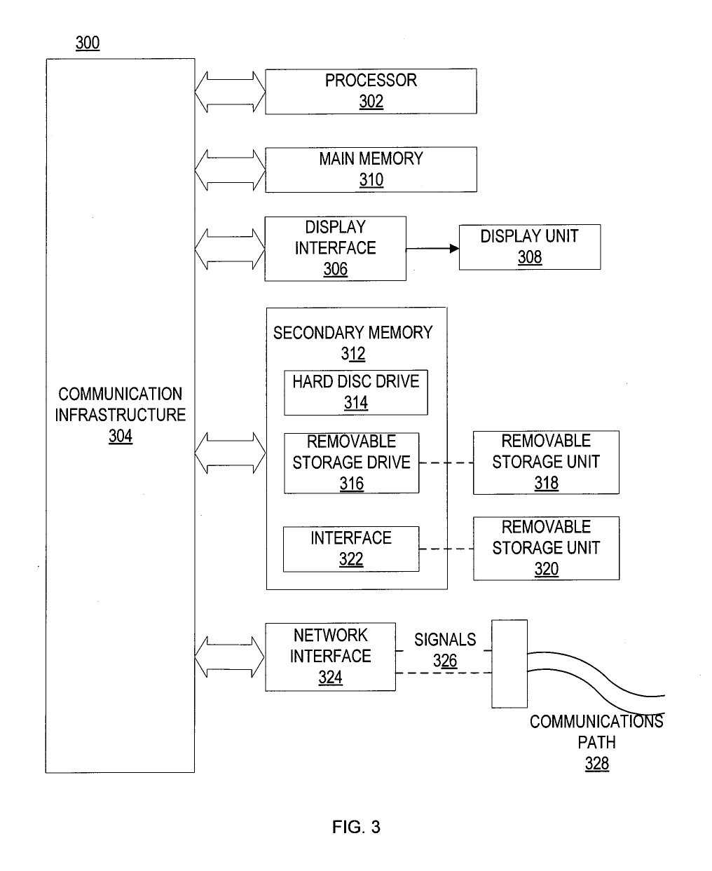

In one embodiment, the invention is directed toward one or more computer systems capable of carrying out the functionality described herein. An example of a computer system 300 is shown in FIG. 3.

Computer system 300 includes one or more processors 302. Processor 302 is connected to a communication infrastructure 304 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures. Computer system 300 can include a display interface 306 that forwards graphics, text, and other data from communication infrastructure 304 (or from a frame buffer not shown) for display on display unit 308.

Computer system 300 also includes a main memory 310, preferably random access memory (RAM), and may also include a secondary memory 312. Secondary memory 312 may include, for example, a hard disk drive 314 and/or a removable storage drive 316, representing a floppy disk drive, a magnetic tape drive, an optical disk drive, an information storage device, etc. Removable storage drive 316 reads from and/or writes to a removable storage unit 318. Removable storage unit 318 represents a floppy disk, a magnetic tape, an optical disk, etc. which is read by, and written to, by removable storage drive 316. Removable storage unit 318 includes a computer usable storage medium having stored therein computer software and/or data.

In alternative embodiments, secondary memory 812 may include other similar devices for allowing computer programs or other instructions to be loaded into computer system 300. Such devices may include, for example, removable storage unit 318, 320 and an interface 322. Examples of secondary memory 312 include a program cartridge and cartridge interface, a removable memory chip (such as an erasable programmable read only memory (EPROM), and/or programmable read only memory (PROM)) with an associated socket, and removable storage unit 318, 320 and/or interface 322, which allow software and data to be transferred from removable storage unit 318, 320 to computer system 300.

Computer system 300 may also include a communications interface, such as a network interface 824. Network interface 324 allows software and data to be transferred between computer system 300 and an external device. Examples of communications interface may include a modem, a network interface (such as an Ethernet card), a communications port, a Personal Computer Memory Card International Association (PCMCIA) slot and card, etc. Software and data transferred via the communications interface are in the form of signals 326 which may be electronic, electromagnetic, optical or other signals capable of being received by the communications interface. These signals are provided to the communications interface via a communications path (e.g., channel) 328. Communications path 328 carries signals 326 and may be implemented using wire or cable, fiber optics, a telephone line, a cellular link, a radio frequency (RF) link, and/or other communications channels.

In this document, the terms “computer program medium” and “computer usable medium” are used to generally refer to media such as removable storage drive such as a hard disk installed in hard disk drive 314, and signals 326. These computer program products provide software to computer system 300. The invention is directed to such computer program products.

Computer programs (also referred to as computer control logic) are stored in main memory 310 and/or secondary memory 312. Computer programs may also be received via the communications interface. Such computer programs, when executed, enable computer system 300 to perform the features, as discussed herein. In particular, the computer programs, when executed, enable processor 302 to perform the features. Accordingly, such computer programs represent controllers of computer system 300.

In an embodiment where the invention is implemented using software, the software may be stored in a computer program product and loaded into computer system 300 using removable storage drive 316, hard drive 314 or network interface 324. The control logic (software), when executed by processor 302, causes processor 302 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

Phrases and terms similar to an “entity” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account. The system may include or interface with any of the foregoing accounts or devices, or a transponder and RFID reader in RF communication with the transponder (which may include a fob). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

Phrases and terms similar to “transaction account” may include any account that may be used to facilitate a financial transaction.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “financial transaction instrument,” “transaction instrument” and/or the plural form of these terms may be used interchangeably throughout to refer to a financial instrument.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to an “item” may include any good, service, information, experience or anything of value.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

In yet another embodiment, the invention is implemented using a combination of both hardware and software.

One skilled in the art will also appreciate that, for security reasons, any databases, systems, devices, servers or other components described herein may consist of any combination thereof at a single location or at multiple locations, wherein each database or system described herein includes any of various suitable security features, such as firewalls, access codes, encryption, decryption, compression, decompression, and/or the like.

In addition to those described above, the various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

As used herein, the term “network” shall include any electronic communications means which orates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the invention is frequently described herein as being implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards And Protocols (1998); Java 2 Complete, various authors, (Sybex 1999); Deborah Ray And Eric Ray, Mastering Html 4.0 (1997); and Loshin, TCP/IP Clearly Explained (1997) and David Gourley and Brian Totty, HTTP, The Definitive Guide (2002), the contents of which are hereby incorporated by reference.

The invention may be described herein in terms of functional block components, screen shots, optional selections and various processing steps. It should be appreciated that such functional blocks may be realized by any number of hardware and/or software components configured to perform the specified functions. For example, various integrated circuit components, e.g., memory elements, processing elements, logic elements, look-up tables, and/or the like may be included, which may carry out a variety of functions under the control of one or more microprocessors or other control devices. Similarly, any software elements may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted any number of conventional techniques for data transmission, signaling, data processing, network control, and/or the like may be employed with the present system and method. Still further, detection or prevention of security issues with a client-side scripting language, such as JavaScript, VBScript or the like is contemplated with the present system and method. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a non-transitory computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity. 100631 Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

Systems, methods and computer program products for fraud prevention and implementing fraud prevention tools are provided. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to ‘at least one of A, B, and/or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. All structural, chemical, and functional equivalents to the elements of the above-described exemplary embodiments that are known to those of ordinary skill in the art are expressly incorporated herein by reference and are intended to be encompassed by the present claims. Further, a list of elements does not include only those elements but may include other elements not expressly listed or inherent to such process, method, article, or apparatus.

1-20. (canceled)

21. A method for performing automatic, real-time fraud detection for electronic transactions, the method comprising:
receiving, by a computer system and from a merchant device, a request to verify an electronic purchase transaction between the merchant and a consumer, wherein the request to verify the electronic purchase transaction includes a computer-readable indication of what is being purchased;
receiving, by the computer system, a request to process the electronic purchase transaction, wherein the request to process the electronic purchase transaction is received from the merchant device over a separate channel from and substantially contemporaneously with receipt of the request to verify the electronic purchase transaction, wherein data comprising a first code specific to what is being purchased is included as a field in the request to process the electronic purchase transaction;
performing, by the computer system, a real-time verification of the electronic purchase transaction, wherein the real-time verification includes:
identifying, based on the computer-readable indication of what is being purchased, a second code specific to what is being purchased; and
comparing the first code to the second code;
generating, by the computer system, a verification message that includes an authorization decision based on the real-time verification; and
based on the authorization decision, the computer system processing the transaction.

22. The method of claim 21, wherein the real-time verification comprises determining a risk factor for the transaction based on an identity of the merchant.

23. The method of claim 22, wherein the authorization decision is based on whether the risk factor is within a range of acceptable values.

24. The method of claim 21, wherein the electronic purchase transaction is conducted via a first transaction account of the consumer, wherein the request to verify the electronic purchase transaction includes a first account code associated with the first transaction account and a second account code associated with a second transaction account of the consumer, and wherein the performing the real-time verification of the transaction includes:
identifying, based on the first account code, a stored account code associated with the second transaction account; and
comparing the second account code to the stored account code.

25. The method of claim 21, further comprising authorizing, by the computer system, the request to verify the transaction based on a comparison of pre-stored registration information of the merchant with one or more elements of the request to verify the transaction.

26. The method of claim 21, further comprising receiving, by the computer system, a request to verify a second transaction from the merchant, wherein the second request is received substantially contemporaneously with the request to verify the transaction.

27. The method of claim 21, wherein the second code is stored in a database local to the computer system that includes a plurality of codes representing a predefined list of high-fraud risk products.

28. The method of claim 21, wherein the authorization decision comprises at least one of the following: correct, incorrect, retry, and unchecked.

29. The method of claim 21, further comprising receiving, by the computer system, a resubmitted corrected request to verify the electronic purchase transaction.

30. The method of claim 29, wherein the resubmitted corrected request to verify the electronic purchase transaction is received in response to an error indication, and wherein a new inquiry is not created for the resubmission.

31. The method of claim 21, wherein the request to process the electronic purchase transaction is sent via a gateway service.

32. The method of claim 21, further comprising generating, by the computer system, a report detailing a response to the request to verify the electronic purchase transaction.

33. A system, comprising:
a networked interface configured to receive requests to authorize purchase transactions from at least one merchant device, wherein each received request includes at least one coded data set identifying what is being purchased;
a database storing codes representing a plurality of products:
a fraud mitigation module configured to provide automated, real-time transaction authorization, wherein the real-time transaction authorization comprises:
identifying, based on the at least one coded dataset, a product code from the database specific to what is being purchased; and
determining if the transaction should be authorized based at least in part, on the identified product code, and;
generating a verification message that includes a computer-generated authorization decision based on the determining.

34. The system of claim 33, wherein the real-time transaction authorization comprises determining a risk factor for the transaction, wherein the risk factor is based, at least in part, on a purchasing history of the consumer and the identified product code.

35. The system of claim 34, wherein the authorization decision is based on whether the risk factor is within a range of acceptable values.

36. The system of claim 34, wherein the purchase transaction is conducted via a transaction account associated with a consumer making the purchase, and wherein the authorization decision is based on the risk factor and on a status of the transaction account.

37. The system of claim 33, wherein one or more fields of the received request to authorize the purchase transaction are automatically populated based on information entered with a separate request to process the transaction.

38. The system of claim 33, wherein the real-time transaction authorization further comprises issuing a user specific vanity URL to access an Internet browser based platform for accessing real-time verification.

39. A non-transitory computer-readable medium having stored thereon instructions executable by a computer system to cause the computer system to perform operations comprising:
receiving, from a merchant, a request to verify a transaction between the merchant and a consumer for a first product, wherein the request to verify the transaction includes an identifier for the first product;
receiving a request to process the transaction for the first product, wherein the request to process the transaction is received from the merchant over a separate channel from and substantially contemporaneously with receipt of the request to verify the transaction, wherein a first product code specific to the first product is included as a field in the request to process the transaction;
a real-time verification of the transaction, wherein the real-time verification includes
identifying, based on the product identifier, a second product code specific to the first product; and
comparing the first product code to the second product code;
generating a verification message that includes an authorization decision based on the real-time verification; and
based an indication that the authorization decision resulted in a positive verification of the transaction, processing the transaction.

40. The non-transitory computer-readable medium of claim 39, wherein the real-time verification comprises determining a risk factor for the transaction, and wherein the authorization decision is based on whether the risk factor is within a range of acceptable values.
